(19) United States
(12) Patent Application Publication
(10) Pub. No.: US 2013/0161047 A1
(43) Pub. Date: Jun. 27, 2013

(54) HANDLE ARRANGEMENT FOR A POWER TOOL

(71) Applicant: Johan Hallendorff, Jonkoping (SE)

(72) Inventor: Johan Hallendorff, Jonkoping (SE)

(73) Assignee: HUSQVARNA AB, Huskvarna (SE)

(21) Appl. No.: 13/820,151

(22) PCT Filed: Sep. 13, 2010
(86) PCT No.: PCT/SE10/50976

§ 371 Date: Mar. 1, 2013

(51) Int. Cl. B25F 5/02

(52) U.S. Cl. CPC B25F 5/02
USPC 173/170

(57) ABSTRACT

A handle arrangement (112) for a power driven hand tool (100). The power driven hand tool (100) includes a main housing (102) arranged at a first end of a guide tube (104). The power driven hand tool (100) also includes a working member arranged at a second end of the guide tube (104). The handle arrangement (112) includes a grip member (114) for user control of the power driven hand tool (100). The handle arrangement (112) is rotatably arranged to the guide tube (104) for rotation in relation to the main housing (102) and to the guide tube (104).

### TECHNICAL FIELD

The present invention relates to power driven hand tools. More particularly, the present invention relates to an improved handle arrangement for the power driven hand tool and the power driven hand tool utilizing the handle arrangement.

### BACKGROUND

Various power driven hand tools (herein after referred to as “power tool”), such as (but not limited to) bandsaws, chainsaws, pole saws, trimmers, and the like, are employed in a variety of industrial, agricultural, gardening and household applications. Power tools conventionally include a main housing, a shaft (hereinafter referred to as guide tube) and a working member. The main housing usually includes a drive unit, such as an electric motor or internal combustion engine. The power tool also includes a drive shaft, enclosed in the guide tube, which extends from the drive unit to transmit power to the working member. In the case of an electrically powered tool, the motor may alternatively be positioned close to the working member while a battery may be positioned in the main housing. In that case no drive shaft is present in the guide tube.

The power tool further includes a rear handle positioned either on the main housing or on the guide tube. The rear handle may include a throttle member and is adapted to be operated by a user for regulating an operational speed of the power tool. A front handle is also provided on the guide tube for facilitating handling of the power tool. Generally, the working member, the guide tube and the main housing are coupled with each other such that there is no relative rotational movement with respect to one another.

During operation of the power tool the user may desire to operate the tool in a position, which is different from a central position, for performing various operations. For example, in the case of a pole saw, the user may desire to rotate the working member, from the central position, where the cutting is performed in a generally horizontal manner, to a position suitable for cutting off branches. Such rotation of the working member also leads to the rotation of the guide tube and the main housing from the central position thereof. Since the rear handle is positioned either on the main housing or on the guide tube, the rear handle also rotates to the position other than the central position. As a result, the user's wrist is bent in an unergonomic way or the handle is rotated in the user's hand such that it is no longer comfortable in the hand.

Various attempts have also been made in the related art, for example, U.S. Patent application No. 20080092398 published on Apr. 24, 2008 and assigned to HEOW, Inc, titled “Combination blower, trimmer and edger for tending vegetation” that discloses a combination blower, trimmer apparatus. The apparatus includes a drive shaft housing connected to a means for rotating a drive shaft seated inside the drive shaft housing. A distal end of the drive shaft is connected to a working head. The apparatus further includes a handle and a throttle handle connected to the drive shaft housing. The drive shaft housing may be rotated by the handle; however both the engine and the throttle handle remain in the same position. A complex mechanism is employed for keeping both the engine and the throttle handle in a fixed position as the drive shaft housing is rotated. Thus, the disclosed apparatus becomes more cumbersome in operation and is constantly subjected to a high amount of wear and tear. Also, the disclosed design does not allow for free rotation of the drive shaft housing, i.e. the guide tube, during operation of the tool.

In light of the foregoing, there is a need for enabling users to carry out various cutting operations while remaining free from any physical discomfort.

### SUMMARY

In view of the above, it is an objective of the present invention to solve or at least reduce the problems discussed above. In particular, the objective is to provide an improved handle arrangement for a power driven hand tool and the power driven hand tool utilizing the improved handle arrangement.

The objective is achieved by the invention as defined by claim 1. In accordance with the present invention, there is provided a handle arrangement to be utilized in a power driven hand tool having a main housing arranged at a first end of a guide tube. The hand tool also includes a working member arranged at a second end of the guide tube. The guide tube may enclose a drive shaft and consequently function as a drive shaft housing. The drive shaft is configured to transmit power from the drive unit to a working member of the power driven hand tool. Also, in some electric power driven hand tools, the electric motor may be placed in close vicinity to the working member and therefore no drive shaft is present in the guide tube. The handle arrangement to be utilized in the power driven hand tool includes a grip member for user control of the power driven hand tool. The handle arrangement is rotatably arranged to the guide tube for rotation in relation to the main housing and to the guide tube. The rotatable arrangement of the handle arrangement on the guide tube helps in keeping the handle arrangement in a comfortable orientation for a user. An advantage of such a handle arrangement is that the handle is not rotated as the rotational position of the tool is changed, and thus remains comfortable in any position of the working member of the power driven hand tool.

According to claim 2, the handle arrangement is freely rotatable in relation to the main housing and to the guide tube to a predefined angle both clockwise and counter-clockwise from a central position. According to claim 3, the predefined angle is approximately 90 degrees in both clockwise and counter-clockwise direction. In some situations, the user may desire to rotate the working member by 90 degrees for performing certain operations such as (but not limited to) branching. This handle arrangement is configured to have a relative rotational motion with respect to the guide tube and the main housing. Therefore, the handle arrangement remains in the same position when the power tool is rotated, and thus allows the user's hand to be in a comfortable position.

According to claim 4, the grip member is provided with a throttle control for user operation. In this case, the handle arrangement may be used both as a throttle control to regulate the speed of the power driven hand tool and as a rear handle for maneuvering the power driven hand tool.

According to claim 5, the grip member is located at a distance from the circumference of the guide tube. Further, according to claim 6, the grip member is arranged in such a way that it may be positioned at an angle in relation to the guide tube. The placement of the grip member at a distance from the guide tube and the positioning of the grip member at an angle in relation to the guide tube give the grip member an ergonomic position, and thus make it convenient for the user to hold the grip member.

According to claim 7, the handle arrangement comprises a supporting member. The supporting member comprises an aperture for securing the grip member. The aperture provides a housing for the grip member and securely places it in the supporting member. Further, since the grip member is fixedly secured to the supporting member and only the supporting member has a relative rotation in relation to the guide tube and the main housing, the grip member always remains in the same position.

According to claim 8, the handle arrangement comprises means for suspension of the power driven hand tool. Specifically, according to claim 9, the means for suspension of the power driven hand tool comprise at least one hook. The hooks may receive a strap of the harness for suspending the power driven hand tool to the body of the user. The suspension of the power tool on the body of the user substantially reduces the strain on the hands and arms of the user. Further, since the strap is attached to the hook carried by the supporting member, the harness will remain stationary even if the guide tube and the main housing rotates between different rotational positions.

According to claim 10, the handle arrangement comprises a generally tubular member 116 arranged to encircle a portion of the guide tube.

According to claim 11, the handle arrangement is supported on a protection member fixedly supported on the guide tube. During utilization of the power driven hand tool, the power driven hand tool is positioned in a manner such that the guide tube remains proximate to the body of the user. However, the protection member prevents that the guide tube contacts the user, and thus prevents excessive wear on the body or clothes of the user.

According to claim 12, the handle arrangement is supported on the protection member in such a way that the handle arrangement is freely rotatable in relation to the main housing and to the guide tube. An advantage of such a handle arrangement is that the user's hand remains comfortable between any position of the working member of the power driven hand tool.

According to claim 13, a power driven hand tool comprises a handle arrangement according to any of the preceding claims.

### BRIEF DESCRIPTION OF THE DRAWINGS

The invention will in the following be described in more detail with reference to the enclosed drawings, wherein:

FIG. 1 illustrates a perspective view of a power driven hand tool, according to an embodiment of the invention;

FIG. 2 illustrates a partial perspective view of a handle arrangement of the power driven hand tool, according to an embodiment of the invention;

FIG. 3 illustrates a partial exploded view of the handle arrangement of the power driven hand tool, according to another embodiment of the invention; and

FIG. 4 illustrates yet another partial exploded view of the handle arrangement, according to an embodiment of the invention.

### DESCRIPTION OF EMBODIMENTS

The present invention will be described more fully hereinafter with reference to the accompanying drawings, in which exemplary embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, one or more aspects of the present invention can be utilized in other embodiments and even other types of devices. In the drawings, like numbers refer to like elements.

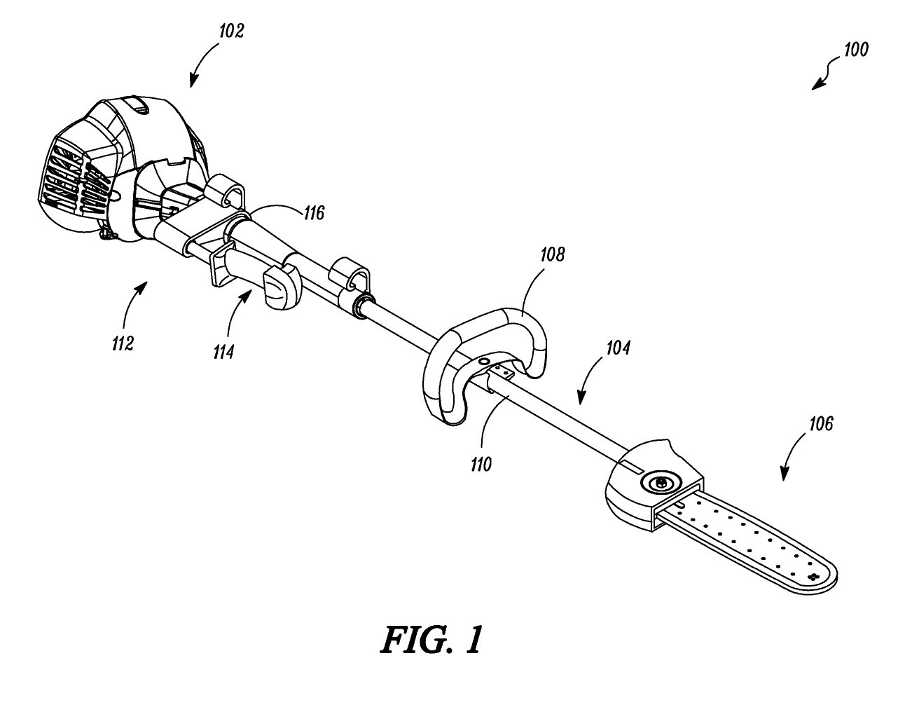

FIG. 1 illustrates a power driven hand tool 100 (hereinafter referred to as “power tool 100”), according to an embodiment of the present invention. In the exemplary embodiment illustrated in FIG. 1, the power tool 100 is a pole saw. However, it is apparent to a person ordinarily skilled in the art that the present invention may also be used in other equipments such as (but not limited to) bandsaws, chainsaws, or other cutting or pruning tools, without departing from the essence of the present invention.

The power tool 100 includes a main housing 102 accommodating a drive unit (not shown). The drive unit may include an electric motor or an internal combustion engine. The power tool 100 further includes a guide tube 104 extending outwardly from the main housing 102. The guide tube 104 encloses a drive shaft and consequently functions as a drive shaft housing. The drive shaft is configured to transmit power from the drive unit to a working member 106 of the power tool 100. As illustrated in the figure, the working member 106 is placed on a free end portion of the guide tube 104. The working member 106 may include a guide bar arrangement having a guide bar and a cutting chain. The cutting chain extends around the guide bar and an end portion of the guide bar is connected to the drive shaft of the power tool 100. The power tool 100 also includes a front handle 108 fixed to the guide tube 104 at an intermediate portion 110 thereof. Alternatively, the front handle 108 may be positioned at any other portion of the guide tube 104, where the front handle 108 remains accessible to the user. The front handle 108 facilitates the rotational movement of the working member 106 of the power tool 100.

In the exemplary embodiment illustrated in FIG. 1, the drive unit is accommodated in the main housing. However, it is apparent to a person ordinarily skilled in the art that the present invention may also be used in electrically powered hand tools, where the electric motor is placed in close vicinity to the working member and therefore no drive shaft is present in the guide tube.

As illustrated in FIG. 1, the power tool 100 further includes a handle arrangement 112. The handle arrangement 112 includes a grip member 114 for user control of the power tool 100. The handle arrangement 112 is rotatably arranged on the guide tube 104. The rotatable arrangement configures the handle arrangement 112 for rotation in relation to the main housing 102 and the guide tube 104. Specifically, the handle arrangement 112 is rotatably arranged on an external surface of a first end portion (not shown in FIG. 1) of the guide tube 104.

In the embodiment illustrated in FIG. 1, the main housing 102, the guide tube 104 and the working member 106 are in a central position, in which the cutting is performed in a generally horizontal direction. During operation of the power tool 100, the user may desire to operate the power tool 100 in a position, which is different form the central position. For example, in the case of the power tool 100 illustrated in the embodiment of FIG. 1, which is a pole saw, the user may require to rotate the working member 106 of the power tool 100 by 90 degrees from the central position, for cutting off branches. Such rotation of the working member 106 also leads to the rotation of the guide tube 104 and the main housing 102 from the central position thereof. For this reason, the handle arrangement 112 is configured in such a way that the handle arrangement 112 is freely rotatable in relation to the main housing 102 and the guide tube 104 to a predefined angle, approximately 90 degrees, in both clockwise and counter-clockwise direction from the central position thereof. In an alternative embodiment the handle arrangement may be rotatable to an angle which is smaller or wider than 90 degrees.

As the handle arrangement is configured for free rotation (within a predetermined angle) in relation to the guide tube (and to the rest of the power tool), the operator can easily rotate the power tool during operation without releasing any locking means and thus without interrupting his/her work, and in the same time keep an ergonomic grip of the power tool.

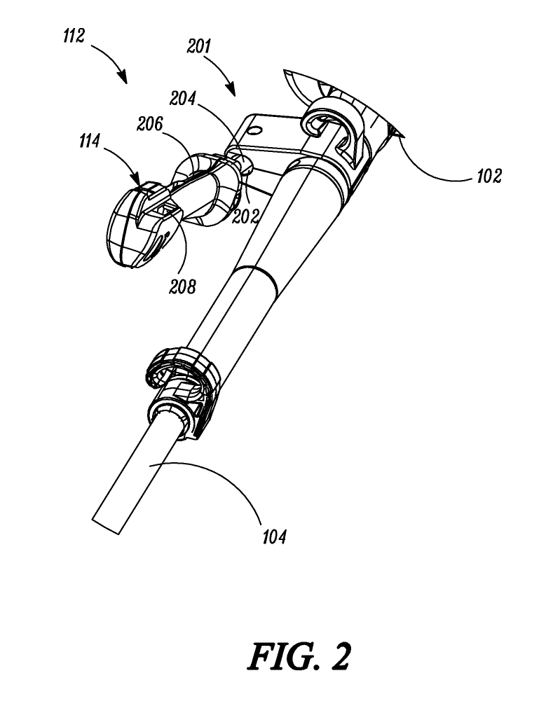

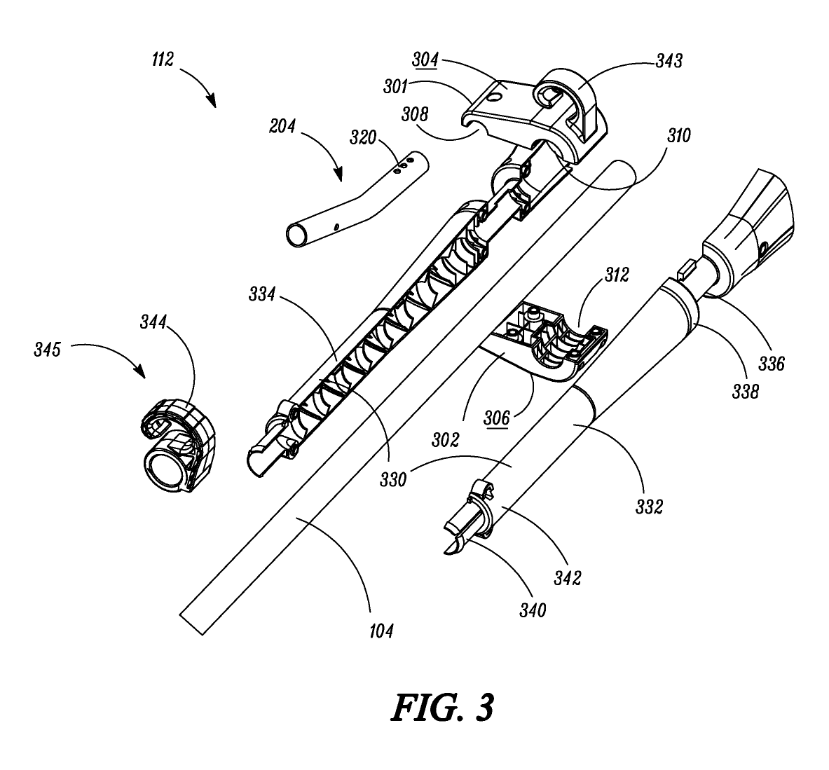

FIG. 2 illustrates a partial perspective view of the handle arrangement 112 of the power tool 100, according to an embodiment of the invention. The handle arrangement 112 includes a supporting member 201. The supporting member 201 includes a tubular member 116 and an aperture 202, for securing the grip member 114. The grip member 114 of the handle arrangement 112 includes an elongated connecting member 204 having a first end portion and a second end portion (illustrated in conjunction with FIG. 3) opposite to the first end portion. In the exemplary embodiment of FIG. 2, the elongated connecting member 204 is in the form of an elongated circular rod; however it is apparent to a person who is ordinarily skilled in the art that it may be of any other shape without deviating from the essence of the invention. The first end portion of the elongated connecting member 204 is received in the aperture 202 provided in the supporting member 201 of the handle arrangement 112. Thus, the grip member 114 is located at a distance from the circumference of the guide tube 104. Further, the elongated connecting member 204 is configured such that the longitudinal direction of the grip member 114 is positioned at an angle in relation to the axial direction of the guide tube 104. This configuration gives the grip member an ergonomic position. Alternatively, the grip member 114 may be positioned in parallel relationship with the guide tube 104, or the grip member 114 may enclose a portion of the guide tube 104.

The grip member 114 further includes a gripping portion 206 disposed on the second end portion of the elongated connecting member 204. Further, in the embodiment illustrated in the figures, the grip member 114 includes a throttle control 208 for user operation. The throttle control 208 may be in the form of one or more buttons disposed on the outer surface of the grip member 114. Further, the throttle control 208 is electrically connected to the drive unit. Specifically, an electrical wire (not shown) connects the throttle control 208 to the drive unit, such that operation of the throttle control 208 regulates the drive unit for achieving variation in the speed of the power tool 100.

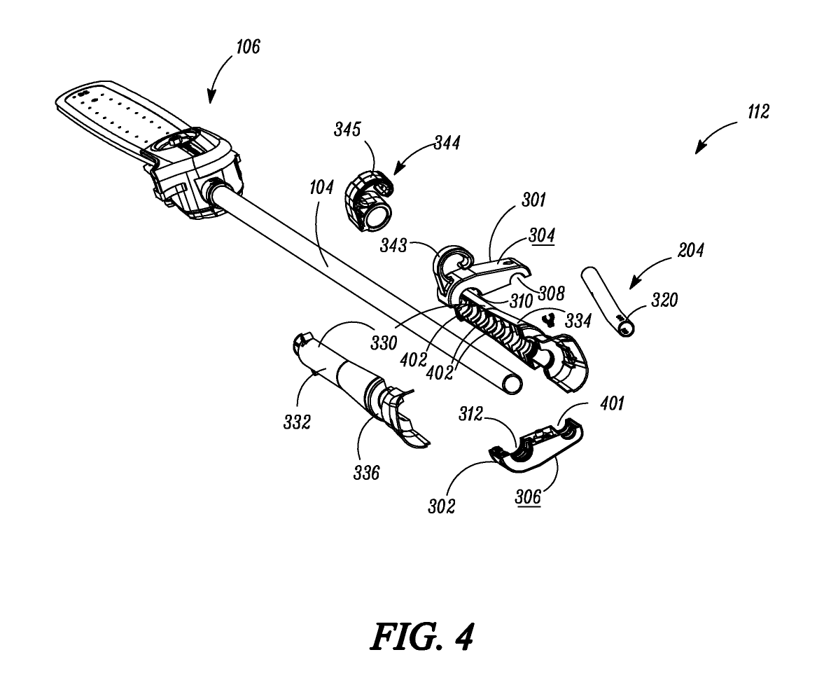

FIG. 3 and FIG. 4 illustrate a partial exploded view of the handle arrangement 112 of the power tool 100, in accordance with an embodiment of the invention. As illustrated in the exploded view, the supporting member 201 includes a top half 301 and a bottom half 302. Each of the top half 301 and the bottom half 302 include outer faces 304, 306 and inner faces having a first semicircular slot 308, 401 and a second semicircular slot 310, 312 respectively.

The top half 301 and the bottom half 302 of the supporting member 201 are configured such that the first semicircular slot 308 of the top half 301 aligns with the first semicircular slot 401 of the bottom half 302 to form the aperture 202 of circular configuration to secure the grip member 114 in position. Specifically, the aperture 202 substantially receives the first end portion 320 of the elongated connecting member 204 of the grip member 114. Thus, the grip member 114 is located at a distance from the circumference of the guide tube 104. In another embodiment of the present invention, the aperture 202 may be of other configuration such as, but not limited to, rectangular or square configuration capable of receiving the first end portion 320 of the elongated connecting member 204. In such embodiment, the elongated connecting member 204 and the slots defined in the top half 301 and bottom half 302 of the supporting member 201 may also be of a corresponding other configuration such as (but not limited to) rectangular or square configuration.

Similarly, the top half 301 and the bottom half 302 of the supporting member 201 are configured such that the second semicircular slot 310 of the top half 301 aligns with the second semicircular slot 312 of the bottom half 302 to form a generally tubular member 116. In one embodiment, the tubular member 116 encircles a portion of the circumference of the guide tube 104. The tubular member 116 is supported on the guide tube 104 in such a way that the supporting member 201 is freely rotatable in relation to the main housing 102 and to the guide tube 104 to an angle of approximately 90 degrees both clockwise and counter-clock wise from a central position. In an alternative embodiment the handle arrangement may be rotatable to an angle which is smaller or wider than 90 degrees.

In the embodiment illustrated in the figures, the handle arrangement 112 is supported on a protection member 330. The protection member 330 is configured to encircle a portion of the guide tube 104. During utilization of the power tool 100, the power tool 100 is positioned in such a manner that the guide tube 104 remains proximate to the body of the user. However, the protection member 330 precludes the guide tube 104 from contacting the user and thus prevents excessive wear on the body and the clothes of the user.

The protection member 330 includes a first hollow semi-cylindrical portion 332 and a second hollow semi-cylindrical portion 334. Upon joining the first hollow semi-cylindrical portion 332 and the second hollow semi-cylindrical portion 334, the protection member 330 gets fixedly supported with the guide tube 104.

The protection member 330 includes an elongated channel defined by a plurality of ribs 402 in each of the first hollow semi-cylindrical portion 332 and the second hollow semi-cylindrical portion 302 of the protection member 330. The portion of the guide tube 104 is received within the elongated channel of the protection member 330 and thus, the protection member 330 encircles the portion of the guide tube 104. Further, the protection member 330 includes a receiving portion 336 at a first end 338 of the protection member 330 for receiving the supporting member 201. The tubular portion of the supporting member 201 is configured to encircle the receiving portion 336 of the protection member 330. The receiving portion 336 and the supporting member 201 are arranged such that the handle arrangement 112 is freely rotatable in relation to the main housing 102 and the guide tube 104 to an angle of approximately 90 degrees both clockwise and counter clockwise from the central position. In an alternative embodiment the handle arrangement may be rotatable to an angle which is smaller or wider than 90 degrees. Specifically, the supporting member 201 is rotatable with respect to the receiving portion 336 of the protection member 330. Thus, the grip member 114 remains in the same position, even if the guide tube 104 and the main housing 102 are in a position other than the central position illustrated in the FIG. 1.

In an alternative embodiment, where the tubular member 116 is placed directly on the guide tube 104, one or more stoppers may be placed on either side of it to prevent the supporting member 201 from being displaced in an axial direction of the guide tube 104.

As illustrated in FIG. 3 and FIG. 4, the handle arrangement 112 also includes a means for suspension of the power tool 100 in a harness. The means for suspension may include hooks, clips, hinges and the like. The suspension of the power tool 100 on the body of the user substantially reduces the strain on the hands and arms of the user.

As illustrated in the embodiment of FIG. 3 and FIG. 4, the supporting member 201 includes at least one hook 343. Another hook 344 is provided on a substantially cylindrical member 345 having a tubular portion defined on the inner surface. In the embodiment illustrated in FIG. 3, both the supporting member 201 and the cylindrical member 345 are supported on the protection member 330 (explained in conjunction with FIG. 3). The tubular portion of the cylindrical member 345 encircles a receiving portion 340 provided at the second end 342 of the protection member 330. Alternatively, the tubular portion of the cylindrical member 345 is placed directly on the guide tube 104 and stoppers are placed at both ends of the cylindrical member 345. The tubular portion of the cylindrical member 345 is configured such that the cylindrical member 345 is freely rotatable in relation to the guide tube 104 and the main housing 102. Further, since the harness is attached to the hooks 343, 344 carried by the supporting member 201 and the cylindrical member 345, the harness will remain stationary even if the guide tube 104 and the main housing 102 rotates between different rotational positions.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A handle arrangement for a power driven hand tool, the power driven hand tool comprising:
a main housing arranged at a first end of a guide tube, and
a working member arranged at a second end of the guide tube, and the handle arrangement comprising a grip member for user control of the power driven hand tool,
wherein the handle arrangement is rotatably arranged on the guide tube for rotation in relation to the main housing and to the guide tube,
wherein the handle arrangement comprises a means for suspension of the power tool in a harness.

2. A handle arrangement according to claim 1, wherein the handle arrangement is freely rotatable in relation to the main housing and to the guide tube to a predefined angle both clockwise and counter-clockwise from a central position.

3. A handle arrangement according to claim 2, wherein the handle arrangement is freely rotatable in relation to the main housing and to the guide tube to an angle of at least 90 degrees both clockwise and counter-clockwise from the central position.

4. A handle arrangement according to claim 1, wherein the grip member is provided with a throttle control for user operation.

5. A handle arrangement according to claim 1, wherein the grip member is located at a distance from the circumference of the guide tube.

6. A handle arrangement according to claim 5, wherein the grip member is arranged in such a way that it may be positioned at an angle in relation to the guide tube.

7. A handle arrangement according to claim 5, wherein the handle arrangement comprises a supporting member, the supporting member comprising an aperture for securing of the grip member.

8. A handle arrangement according to claim 1, wherein the handle arrangement comprises means for suspension of the power driven hand tool.

9. A handle arrangement according to claim 8, wherein the means for suspension of the power driven hand tool comprise at least one hook.

10. A handle arrangement according to claim 1, wherein the handle arrangement comprises a generally tubular member arranged to encircle a portion of the guide tube.

11. A handle arrangement according to claim 1, wherein the handle arrangement is supported on a protection member fixedly supported on the guide tube.

12. A handle arrangement according to claim 11, wherein the handle arrangement is supported on the protection member in such a way that the handle arrangement is freely rotatable in relation to the main housing and to the guide tube.

13. A power driven hand tool comprising:
a main housing arranged at a first end of a guide tube;
a working member arranged at a second end of the guide tube; and
a handle arrangement comprising a grip member for user control of the power driven hand tool,
wherein the handle arrangement is rotatably arranged on the guide tube for rotation in relation to the main housing and to the guide tube, and
wherein the handle arrangement comprises a means for suspension of the power tool in a harness.

14. A power driven hand tool according to claim 13, wherein the handle arrangement is freely rotatable in relation to the main housing and to the guide tube to a predefined angle both clockwise and counter-clockwise from a central position.

15. A power driven hand tool according to claim 13, wherein the grip member is provided with a throttle control for user operation.

16. A power driven hand tool according to claim 13, wherein the grip member is located at a distance from the circumference of the guide tube.

17. A power driven hand tool according to claim 16, wherein the grip member is arranged in such a way that it may be positioned at an angle in relation to the guide tube.

18. A power driven hand tool according to claim 16, wherein the handle arrangement comprises a supporting member, the supporting member comprising an aperture for securing of the grip member.

19. A power driven hand tool according to claim 13, wherein the handle arrangement comprises a generally tubular member arranged to encircle a portion of the guide tube.

20. A power driven hand tool according to claim 13, wherein the handle arrangement is supported on a protection member fixedly supported on the guide tube.
